(19) United States
(12) Patent Application Publication
(10) Pub. No.: US 2007/0223663 A1
(43) Pub. Date: Sep. 27, 2007

(54) CUSTOMIZED RING BACK TONE SERVICE FOR WIRELINE SUBSCRIBERS

(75) Inventors: David S. Benco, Winfield, IL (US); Paresh C. Kanabar, Naperville, IL (US); John C. V. Nguyen, Naperville, IL (US); Huixian Song, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies, Inc., Murray Hill, NJ (US)

(21) Appl. No.: 11/277,409

(22) Filed: Mar. 24, 2006

(51) Int. Cl. H04M 15/06; H04M 1/56

(52) U.S. Cl. 379/142.01

(57) ABSTRACT

Methods and systems are presented for providing custom ring back tones to parties calling a wireline subscriber, in which an end office selectively connects the incoming call to a ring back tone server to hear a custom ring back tone until the wireline phone is answered, after which the incoming call is connected to the called wireline device.

### FIELD OF THE INVENTION

This invention relates generally to the field of telecommunication systems, and more particularly to wireline telecommunications systems and methods for providing a calling party with a customized ring back tone when placing a call to a wireline telephone.

### BACKGROUND OF THE INVENTION

In conventional wireline telephone service, a calling party will dial a number and will hear a “ring” sound while the called subscriber's telephone device is alerted to the incoming call. This familiar ring sound is provided to the caller by tone generation equipment in the local end office (e.g., class 5 switch) connected to the called telephone while the end office notifies the called party by causing the called telephone to ring. Once the called party answers the call, the ring sound is discontinued and the caller is connected to the called telephone to begin a conversation. Customized ring back tone (CRBT) services have thusfar only been offered to mobile phone users, in which wireless service providers allow subscribers to select a special ring back tone, such as a song or advertisement that is provided to callers from the time of the call set up to when the called party answers. In wireless networks, the CRBT service and CRBT routing information are obtained from the called party's HLR or WIN SCP database through a MAP operation. However, the equipment in existing wireline end offices does not allow this type of custom ring back tone service to be offered to wireline subscribers. Thus, there is a need for systems and techniques for providing custom ring back tone services to wireline customers.

### SUMMARY OF THE INVENTION

The following is a summary of one or more aspects of the invention provided in order to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The various aspects of the present invention relate to the provision of customized ring back tone (CRBT) services for wireline or landline subscribers, wherein the called wireline subscriber telephone device will be alerted to the existence of an incoming call while the caller (wireless, wireline, VoIP, etc.) is provided with a customized ring back tone, such as music, advertisements, pre-recorded messages, etc., where the particular tone may be selected according to the identity of the calling party, time of day, or other selection criterion.

This new service can be provided to replace the traditional audible ringing or beeping sound using a ring back tone server connected to the public switched telephone network (PSTN)) or other landline network, with the local end offices providing selective connection of incoming calls to the ring back tone server so that the caller hears a pre-selected audio tone before the called subscriber's wireline phone is answered. The end office may provide the ring back tone server with caller ID type information, wherein the selection of the ring back tone may be based on the caller's identity, time of day, etc. In addition, the subscriber may have the ability to program or update the ring back tones for individual calling parties, times, etc., using a telephone or through an on-line internet programming environment. The invention may thus facilitate provision of the popular CRBT services to wireline subscribers without significant upgrade costs for wireline telephone service providers.

In accordance with one or more aspects of the present invention, wireline telecommunications systems are provided, including a network and a ring back tone server operatively coupled with the network to store at least one ring back tone associated with a wireline subscriber telephone device and to provide the ring back tone to the network. The system further comprises an end office coupled with the network and with the wireline subscriber telephone device, where the end office includes a linking system operative to establish communicative links with the network and with the wireline subscriber telephone device. The linking system includes a ring back tone switching apparatus that selectively couples an incoming call link from the network to a ring back tone server link in a first state so that a calling party hears a ring back tone designated by the called party before the wireline subscriber telephone is answered. After the wireline subscriber telephone is answered, the end office couples the incoming call to the wireline subscriber telephone in a second state.

In certain embodiments, the end office stores a custom ring back tone indicator that indicates whether a subscriber has subscribed to the CRBT service, as well as ring back tone routing information identifying the ring back tone server. When an incoming call is received at the wireline network, the end office checks the CRBT indicator to determine whether the call is for a CRBT subscriber. If so, the end office uses the routing information to setup a first call leg to the ring back tone server and couples the incoming call link with the ring back tone server link. After the subscriber device is answered, the end office disconnects the first call leg and connects the incoming call to the called wireline device. The ring back tone server may store multiple tones associated with a given wireline subscriber telephone, and may selectively provide one of the ring back tones to the network according to calling party information and/or according to the current time. In one implementation, the end office provides the calling party information (e.g., caller ID) to the ring back tone server for selecting a ring back tone in setting up the first call leg.

Other aspects of the invention relate to a method for providing custom ring back tones to parties calling a wireline subscriber. The method involves receiving an incoming call for a wireline subscriber telephone device at an end office, alerting the called wireline subscriber telephone device, coupling the incoming call through a wireline network to a ring back tone server and providing a ring back tone associated with the called party from the ring back tone server through the wireline network to a calling party before the called wireline subscriber telephone device is answered. The method also includes coupling the incoming call to the called wireline subscriber telephone device after the called wireline subscriber telephone device is answered. The ring back tone may be provided by selecting one of a plurality of ring back tones stored in the ring back tone server at least in part based on an identity of the calling party and/or current time, and the method may further include allowing a subscriber to program the ring back tone server to associate particular ring back tones with particular calling parties or particular times.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a system level diagram illustrating a telecommunications system including a wireline network with a custom ring back tone (CRBT) system in accordance with one or more aspects of the present invention;

FIG. 2 is a call flow diagram illustrating operation of the CRBT system of FIG. 1; and

FIG. 3 is a flow diagram illustrating an exemplary method in accordance with the invention.

### DETAILED DESCRIPTION

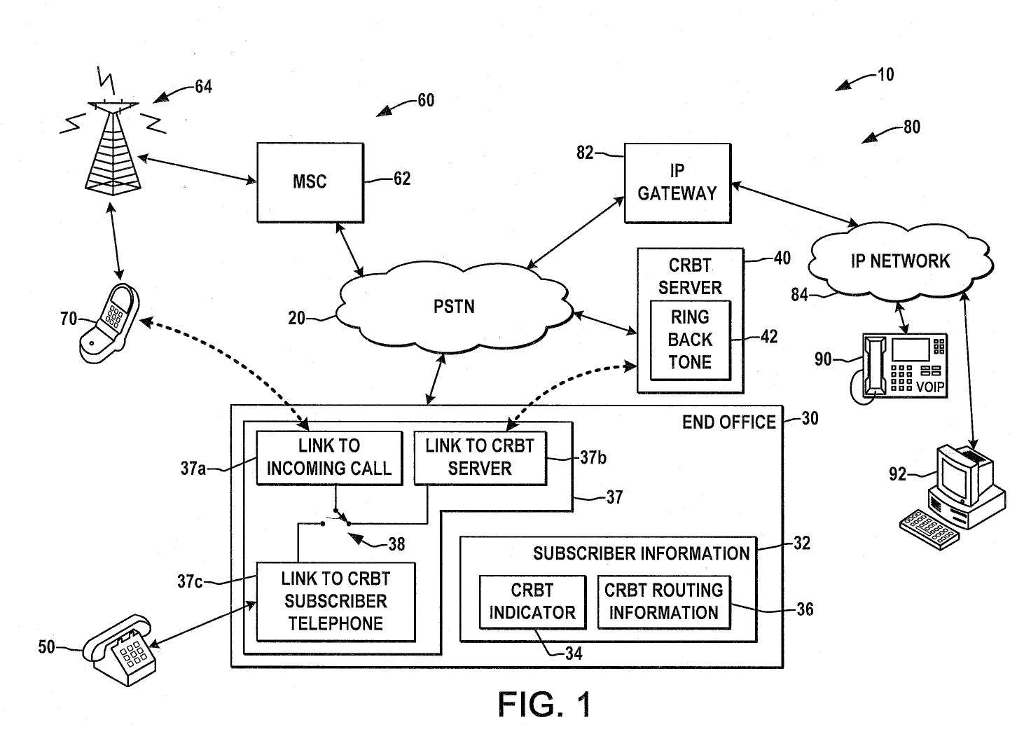

Referring now to the figures, wherein the showings are for purposes of illustrating the exemplary embodiments only and not for purposes of limiting the claimed subject matter, FIG. 1 provides a view of a system into which the presently described embodiments may be incorporated. Several embodiments or implementations of the various aspects of the present invention are hereinafter illustrated and described in conjunction with the drawings, wherein like reference numerals are used to refer to like elements.

As shown in FIG. 1, an exemplary telecommunications system 10 includes a wireline network (PSTN) 20 operatively coupled with one or more end offices 30 having all the normal operational functionality of conventional wireline end offices in addition to the CRBT features illustrated and described herein for providing telephone services to wireline telephone devices 50, one of which is shown in FIG. 1. The PSTN 20 is operatively coupled using various gateways or other hardware/software interfaces (not shown) with one or more wireless networks 60 and/or Internet Protocol (IP) based networks 80 allowing connection of calls between wireline telephones 50, wireless phones or other mobile units 70 and IP-based communications equipment such as voice-over-IP (VoIP) phones 90 and/or computers 92. The wireless network 60 can include one or more mobile switching centers (MSCs) 62 and associated base station systems 64, as well as data stores such as HLRs and VLRs (not shown) providing wireless communications services for mobile phones 70, where the illustrated MSC 62 is operatively coupled with the PSTN 20 allowing calls between wireline phone 50 and wireless device 70. The IP-based system 80 provides an IP gateway 82 coupling an IP network 84 with the PSTN 20 for providing call services between wireline phones 50 and IP-based devices 90, 92. The various networks 20, 60, 80 thus provide communicative connection of various communications devices and network elements allowing various telephones, mobile units, computers, digital assistants, etc. to communicate with one another for exchange or transfer of voice and/or data or other information therebetween, wherein the telecommunications system 10 can include any number of wireless and wireline networks, wherein only a few exemplary elements are illustrated in FIG. 1 for purposes of description without obscuring the various features and aspects of the invention.

The wireline CRBT system includes a ring back tone (CRBT) server 40 operatively coupled with the PSTN 20 and a modified or reconfigured end office 30, wherein the CRBT server 40 stores and provides playback of one or more subscriber selected ring back tones 42. Any suitable data store, logic, hardware, software, etc., may be used to implement the ring back tone server 40 having the functionality set forth herein, wherein a network server having other functions may be programmed and otherwise suitably configured to perform the functions of the ring back tone server 40 in association with a PSTN 20 or other wireline telecommunications network. The illustrated server 40, moreover, can store a plurality of ring back tones associated with the wireline subscriber telephone device 50 and selectively provides one of the ring back tones to the network according to calling party information identifying the calling party associated with an incoming call, the time the call is placed, or other selection criteria. A wireline CRBT subscriber associated with the wireline phone 50 may pre-select one or more special tones 42, including without limitation songs, melodies, commercial messages, or other predefined sound(s) to be provided to a particular caller, from the time the call is set up to when the called party answers, instead of the traditional audible ringing or beeping sound heard when placing calls to non-CRBT subscribers. In the illustrated embodiments, moreover, the wireline CRBT subscriber can define the ring back tones 42 by caller and/or time using internet-based programming interfaces, such as through a computer 92, or by calling a number that can reach the CRBT server 42.

The end office 30 is operatively coupled with the PSTN 20 and the wireline phone 50, and includes a linking system 37 to establish links 37a-37c with the PSTN 20 and the wireline phones 50, where the linking system 37 can be any suitable hardware, software, or combinations thereof. In particular, the linking system 37 of the end office 30 establishes links 37a and 37b via the PSTN 20 including incoming call links 37a and links 37b to the CRBT server 40, and also establishes a link 37c to the subscriber telephone 50. In addition, the end office 30 includes a ring back tone switching apparatus shown in FIG. 1 schematically as switch 38, which operates to couple the incoming call and CRBT server links 37a and 37b in a first state to allow a calling party to hear a selected ring back tone 42 associated with the called party before the wireline subscriber telephone device 50 is answered, where the switch 38 can be implemented in any suitable hardware and/or software.

Thereafter, the switching apparatus 38 couples the incoming call link 37a with the wireline telephone link 37c in a second operational state after the wireline subscriber telephone device 50 is answered, where the phone 50 may be answered by the subscriber or by an answering machine or other answering device associated with the phone 50. The illustrated end office 30, moreover, stores subscriber information 32 for wireline subscriber telephone devices 50, including a custom ring back tone indicator flag, bit, or other value 34 that indicates whether a subscriber has subscribed to a wireline CRBT service, along with associated CRBT routing information 36, such as an address or other value specifying a particular ring back tone server 40 that stores the corresponding predefined tones 42. The exemplary implementation allows relatively minimal updating of preexisting end offices 30 to accommodate provision of CRBT services to wireline subscribers 50, wherein CRBT server(s) 40 can be provided at any location accessible through the PSTN 20 to service one or more end offices 30.

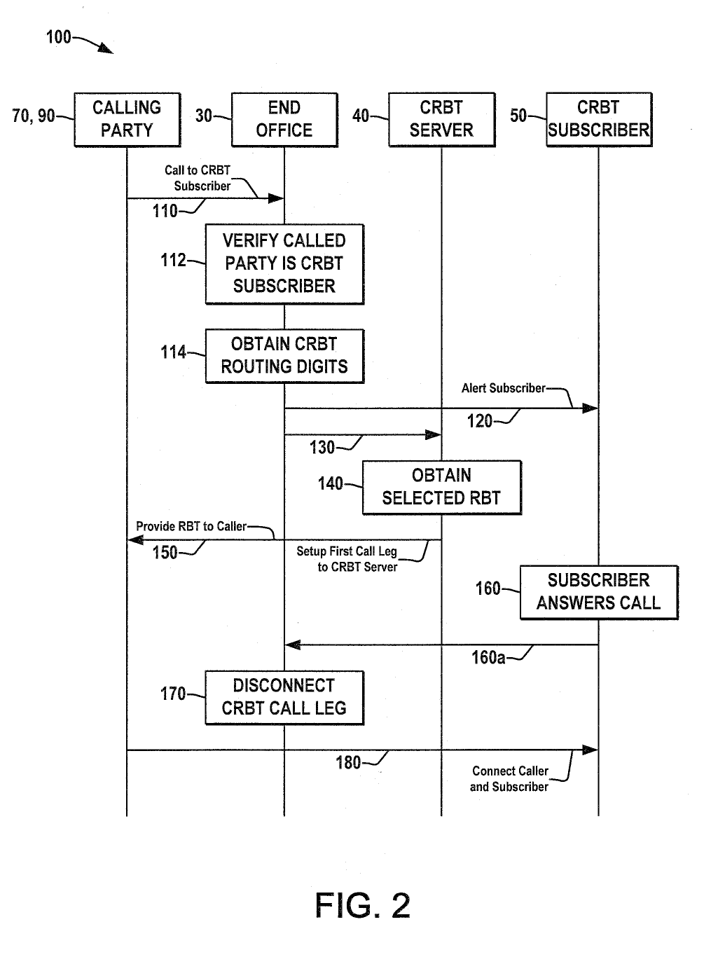

Referring also to the call flow 100 in FIG. 2, in operation, a calling party, such as mobile unit 70, VoIP phone 90, or even another wireline phone (not shown), places a call (incoming call 110 in FIG. 2) for the wireline CRBT subscriber telephone 50. Upon receiving the incoming call 110, the end office 30 verifies whether the called party 50 is a CRBT subscriber (112 in FIG. 2), for instance, by checking the CRBT indicator 34 associated with the called number (FIG. 1). Upon determining that the subscriber has subscribed to the wireline CRBT service, the end office 30 obtains the CRBT routing information 36 (114 in FIG. 2) and proceeds to alert the subscriber (causes the wireline phone 50 to ring at 120 in FIG. 2) and sets up a first call leg to the CRBT server 40 to couple the network incoming call link 37a with the network ring back tone server link 37b (FIG. 1). The call setup can be accomplished by any suitable messaging and data exchange, which in the illustrated embodiments, includes the end office 30 providing the caller identity information to the server 40 (at 130 in FIG. 2). The server 40 uses the caller identity information and/or the current time to select or otherwise obtain the appropriate ring back tone associated with the called party (140 in FIG. 2), and the first call leg is setup (150 in FIG. 2) with the server 40 providing the selected custom ring back tone to the calling party 70, 90 while the end office 30 continues to alert the called subscriber phone 50. During this time, the switching apparatus 38 in FIG. 1 is in a first state effectively connecting the links 37a and 37b. As shown in FIG. 2, at some point, the subscriber answers the wireline device 50 (at 160, 160a in FIG. 2), after which the first call leg is disconnected by the end office 30 (at 170 in FIG. 2), and the end office 30 connects the incoming call to the called wireline subscriber telephone device 50 at 180 in FIG. 2, with the switching apparatus 38 being set to a second state to couple the phone link 37c to the incoming call link 37a.

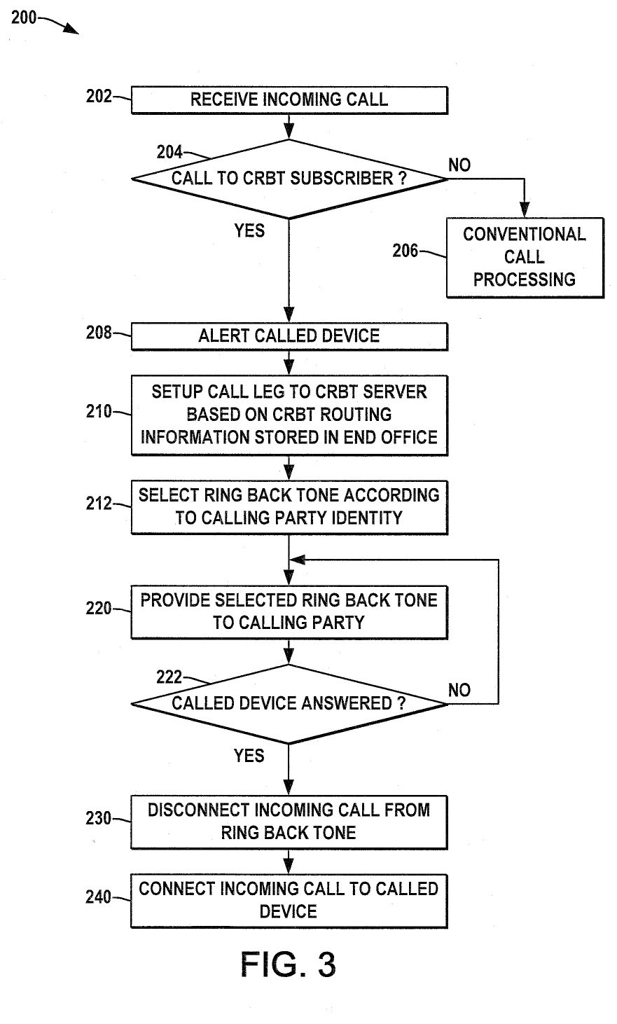

FIG. 3 illustrates an exemplary method 200 for providing custom ring back tones to parties calling a wireline subscriber in accordance with certain aspects of the present invention, which may be implemented in the illustrated system 10 of FIG. 1 or in other systems. Although the exemplary method 200 is illustrated and described below in the form of a series of acts or events, it will be appreciated that the various methods of the invention are not limited by the illustrated ordering of such acts or events except as specifically set forth herein. In this regard, except as specifically provided hereinafter, some acts or events may occur in different order and/or concurrently with other acts or events apart from those illustrated and described herein, and not all illustrated steps may be required to implement a process or method in accordance with the present invention. The illustrated method 200 and other methods of the invention may be implemented in hardware, software, or combinations thereof, in order to provide custom ring back tone services to wireline subscribers, wherein the method 200 can be practiced in hardware and/or software of the above described end office 30 and CRBT server 40. However, the invention is not limited to the specific applications and implementations illustrated and described herein.

The method 200 begins at 202, with receipt at an end office 30 of an incoming call to a wireline subscriber 50. The end office determines at 204 whether the called subscriber is a CRBT service subscriber, and if not (NO at 204), conventional call processing is thereafter employed at 206 to attempt to deliver the call to the subscriber telephone. If the call is to a wireline CRBT subscriber (YES at 204), the called wireline device 50 is alerted at 208, a call leg is setup to the CRBT server (server 40) at 210 based on CRBT routing information (routing information 36) stored in the end office 30, and a user defined ring back tone 42 is selected at 212 (e.g., by the CRBT server 40) according to the identity of the calling party. The tone selection at 212 may alternatively or in combination be based on the current time or other selection factor(s). At 220, the incoming call is coupled through a wireline network (e.g., PSTN 20 in FIG. 1) to the ring back tone server 40 and the selected ring back tone is provided to the calling party 70, 90. A determination is made at 222 as to whether the called subscriber phone 50 has been answered, and if not (NO at 222) the method 200 returns to 220 to continue providing the selected ring back tone to the caller 70, 90. Once the called phone 50 has been answered (YES at 222), the incoming call is disconnected at 230 from the ring back tine server 40 and the incoming call is coupled at 240 to the called wireline subscriber telephone device 50, thereby completing the call.

While the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A wireline telecommunications system for providing telephone service to wireline subscribers, the wireline telecommunications system comprising:
a network;
a ring back tone server operatively coupled with the network to store at least one ring back tone associated with a wireline subscriber telephone device and to provide the ring back tone to the network; and
an end office operatively coupled with the network and with the wireline subscriber telephone device and including a linking system operative to establish communicative links with the network and with the wireline subscriber telephone device, the linking system including a ring back tone switching apparatus operative in a first state to selectively couple a network incoming call link with a network ring back tone server link for an incoming call to the wireline subscriber telephone device so that a calling party hears a ring back tone associated with a called party wireline subscriber telephone device before the wireline subscriber telephone device answers, and operative in a second state after the wireline subscriber telephone device answers to couple the network incoming call link with the wireline subscriber telephone device.

2. The wireline telecommunications system of claim 1, wherein the end office stores subscriber information for wireline subscriber telephone devices including a custom ring back tone indicator that indicates whether a subscriber has subscribed to a wireline custom ring back tone service, and custom ring back tone routing information identifying the ring back tone server.

3. The wireline telecommunications system of claim 2, wherein the ring back tone server stores a plurality of ring back tones associated with the wireline subscriber telephone device and selectively provides one of the ring back tones to the network according to calling party information identifying the calling party associated with the incoming call.

4. The wireline telecommunications system of claim 3, wherein upon receiving the incoming call for the wireline subscriber telephone device, the end office determines that the subscriber has subscribed to the wireline custom ring back tone service, uses the custom ring back tone routing information to setup a first call leg to the ring back tone server, and couples the network incoming call link with the network ring back tone server link, and wherein after the wireline subscriber telephone device answers, the end office disconnects the first call leg and connects the incoming call to the called wireline subscriber telephone device.

5. The wireline telecommunications system of claim 4, wherein the end office provides the calling party information to the ring back tone server for selecting a ring back tone for setting up the first call leg.

6. The wireline telecommunications system of claim 2, wherein upon receiving the incoming call for the wireline subscriber telephone device, the end office determines that the subscriber has subscribed to the wireline custom ring back tone service, uses the custom ring back tone routing information to setup a first call leg to the ring back tone server, and couples the network incoming call link with the network ring back tone server link, and wherein after the wireline subscriber telephone device answers, the end office disconnects the first call leg and connects the incoming call to the called wireline subscriber telephone device.

7. The wireline telecommunications system of claim 1, wherein upon receiving the incoming call for the wireline subscriber telephone device, the end office determines that the subscriber has subscribed to the wireline custom ring back tone service, sets up a first call leg to the ring back tone server, and couples the network incoming call link with the network ring back tone server link, and wherein after the wireline subscriber telephone device answers, the end office disconnects the first call leg and connects the incoming call to the called wireline subscriber telephone device.

8. The wireline telecommunications system of claim 1, wherein the ring back tone server stores a plurality of ring back tones associated with the wireline subscriber telephone device and selectively provides one of the ring back tones to the network according to calling party information identifying the calling party associated with the incoming call.

9. The wireline telecommunications system of claim 8, wherein the end office provides the calling party information to the ring back tone server for selecting a ring back tone for setting up the first call leg.

10. The wireline telecommunications system of claim 8, wherein the ring back tone server selectively provides one of the ring back tones to the network according to calling party information and according to the current time.

11. The wireline telecommunications system of claim 8, further comprising means for programming the ring back tone server by a subscriber to associate particular ring back tones with particular calling party information.

12. A customized ring back tone system for wireline subscribers, the system comprising:
a ring back tone server operatively coupled with a wireline telecommunications network and storing at least one ring back tone associated with a wireline subscriber telephone device and to provide the ring back tone to the network; and
an end office operatively coupled with the network and with the wireline subscriber telephone device, the end office including means for establishing communicative links with the network and with the wireline subscriber telephone device, and switching means for selectively coupling an incoming call link with a ring back tone server link in a first state before the wireline subscriber telephone device answers, and for coupling the network incoming call link with the wireline subscriber telephone device in a second state after the wireline subscriber telephone device answers.

13. The ring back tone system of claim 12, wherein the end office stores subscriber information for wireline subscriber telephone devices including a custom ring back tone indicator that indicates whether a subscriber has subscribed to a wireline custom ring back tone service, and custom ring back tone routing information identifying the ring back tone server.

14. The ring back tone system of claim 12, wherein the ring back tone server stores a plurality of ring back tones associated with the wireline subscriber telephone device and selectively provides one of the ring back tones to the calling party according to calling party information identifying the calling party associated with the incoming call.

15. The ring back tone system of claim 12, wherein the end office provides the calling party information to the ring back tone server for selecting a ring back tone for setting up the first call leg.

16. The ring back tone system of claim 12, wherein upon receiving the incoming call for the wireline subscriber telephone device, the end office determines that the subscriber has subscribed to the wireline custom ring back tone service, sets up a first call leg to the ring back tone server, and couples the network incoming call link with the network ring back tone server link, and wherein after the wireline subscriber telephone device answers, the end office disconnects the first call leg and connects the incoming call to the called wireline subscriber telephone device.

17. A method for providing custom ring back tones to parties calling a wireline subscriber, the method comprising:
receiving an incoming call for a wireline subscriber telephone device at an end office;
alerting the called wireline subscriber telephone device;
before the called wireline subscriber telephone device is answered, coupling the incoming call through a wireline network to a ring back tone server and providing a ring back tone associated with a called party wireline subscriber telephone device from the ring back tone server through the wireline network to a calling party; and
after the called wireline subscriber telephone device is answered, coupling the incoming call to the called wireline subscriber telephone device.

18. The method of claim 17, wherein providing the ring back tone comprises selecting one of a plurality of ring back tones stored in the ring back tone server at least in part based on an identity of the calling party.

19. The method of claim 17, wherein providing the ring back tone comprises selecting one of a plurality of ring back tones stored in the ring back tone server at least in part based on an time.

20. The method of claim 17, further comprising allowing a subscriber to program the ring back tone server to associate particular ring back tones with particular calling parties or particular times.
